(19) United States
(12) Patent Application Publication
(10) Pub. No.: US 2010/0006412 A1
(43) Pub. Date: Jan. 14, 2010

(54) KEYCAP AND PRESS KEY STRUCTURE USING THE SAME

(75) Inventors: YI-CHEN WANG, Yilan County (TW); LEI-LUNG TSAI, Yilan County (TW); YUNG-NIEN CHAI, Yilan County (TW)

Correspondence Address: WPAT, PC;INTELLECTUAL PROPERTY ATTORNEYS, 7225 BEVERLY ST., ANNANDALE, VA, 22003, US

(73) Assignee: DARFON ELECTRONICS CORP., Taoyuan (TW)

(21) Appl. No.: 12/488,782

(22) Filed: Jun. 22, 2009

(30) Foreign Application Priority Data
Jul. 11, 2008 (TW) 097126336

(51) Int. Cl. H01H 13/04

(52) U.S. Cl. 200/314

(57) ABSTRACT

A keycap and a press key structure along with a keyboard using the same are disclosed. The keycap, being comprised of a top and a bottom having a concave-convex structure formed thereon, is structured for allowing light to pass therethrough. There is a connecting component sandwiched between the keycap and a substrate in a manner that it is pivotally connected to the two in respective for allowing the keycap to move up and down in relative to the substrate. Moreover, there is at least a light source being disposed between the keycap and the substrate for projecting light to the concave-convex structure on the keycap′ bottom and out of the keycap through the top thereof after being uniformly scattered by the concave-convex structure. Thus a press key is constructed. It is noted that by arranging a plurality of the aforesaid press keys in an array, a keyboard is constructed.

### FIELD OF THE INVENTION

The present invention relates to a keycap, and more particularly, to a keycap capable of using a concave-convex structure formed on the bottom thereof to uniformly scatter the light projected on the bottom and then allowing the light to be projected out from the top of the keycap evenly, and also related to a press key structure and keyboard using such keycap.

### BACKGROUND OF THE INVENTION

Conventionally, a press key structure is usually constructed with a scissors-type elastic structure, as shown in FIG. 1 and FIG. 2. The aforesaid press key structure 10 is comprised of: a keycap 11, a substrate 12 and a connecting component sandwiched between the keycap 13 and the substrate 14. As shown in FIG. 2, the connecting component 13, being composed of a first supporting arm 131 and a second supporting arm 132, is configured in a manner that the two supporting arms 131, 132 are pivotally coupled with each other at the middle thereof forming an X-shaped structure while pivotally connecting their top ends to the bottom of the keycap 11 and connecting their bottom ends to the substrate 12, by that the keycap 11 is connected to the substrate 12 while allowing the keycap 11 to move up and down in relative to the substrate 12. In addition, in correspondence to a light source 14 disposed between the keycap 11 and the substrate 12, the keycap 11, being made of a transparent material, can have a pattern 111 of good light transmittance formed on the top thereof while enabling light to be blocked by the other area of the keycap 11 except the pattern 111. There can be various ways for formed such pattern 111. One of which is a process comprising the steps of: proving a keycap 11 made of a transparent material while covering a portion of the top thereof for forming a specific pattern 111; coating or spraying an opaque layer on the top of the keycap 11; etching the covered portion of the keycap's top so as to form the specific pattern 111 of good light transmittance.

With the aforesaid press key structure, the light emitted from the light source 14 and projected onto the bottom of the keycap 11 is able to travel passing the transparent pattern 111 and then project out of the keycap 11 from the top thereof. Thereby, the press key structure 10 is configured with a glittering pattern 111. However, considering the size of the press key and the space available therein, it is customary to use light emitting diode (LED) as the light source 14. As the LED is a directional lighting device that the light emitted therefrom is concentrated, it might not light up the whole transparent pattern 111 by the same intensity when the transparent pattern 111 is covering a comparatively larger area on the keycap 11. As shown in FIG. 1, when the light source 14 is disposed at a position on the left to the transparent pattern 111, the left portion of the pattern 111 might be brighter than the its right portion. Although the aforesaid problem of uneven illumination can be solved by disposing more than one light sources between the keycap 11 and the substrate 12, it can cause the manufacturing cost to increase, not to mention that the increasing complexity in its manufacturing process as well as the availability of space in the press key for accommodating the plural light sources and the consequent weight increasing.

### SUMMARY OF THE INVENTION

In view of the disadvantages of prior art, the object of the present invention is to provide a keycap capable of allowing light to be projected out from the top thereof evenly, and thus to provide a press key structure and keyboard using such keycap.

To achieve the above object, the present invention provides keycap and a press key structure along with a keyboard using the same. The keycap, being comprised of a top and a bottom having a concave-convex structure formed thereon, is structured for allowing light to pass therethrough, and there is a connecting component sandwiched between the keycap and a substrate in a manner that it is pivotally connected to the two in respective for allowing the keycap to move up and down in relative to the substrate. Moreover, there is at least a light source being disposed between the keycap and the substrate for projecting light to the concave-convex structure on the keycap′ bottom and out of the keycap through the top thereof after being uniformly scattered by the concave-convex structure. Thus a press key is constructed. It is noted that by arranging a plurality of the aforesaid press keys in an array, a keyboard is constructed.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a front view of a conventional press key structure.

FIG. 2 is an A-A sectional view of FIG. 1.

FIG. 3 is a front view of a keycap according to an embodiment of the invention,

FIG. 4 is a B-B sectional view of FIG. 3.

FIG. 5 is a C-C sectional view of FIG. 3.

FIG. 6 is a schematic diagram showing a keyboard composing of a plurality of press key structures according to the present invention.

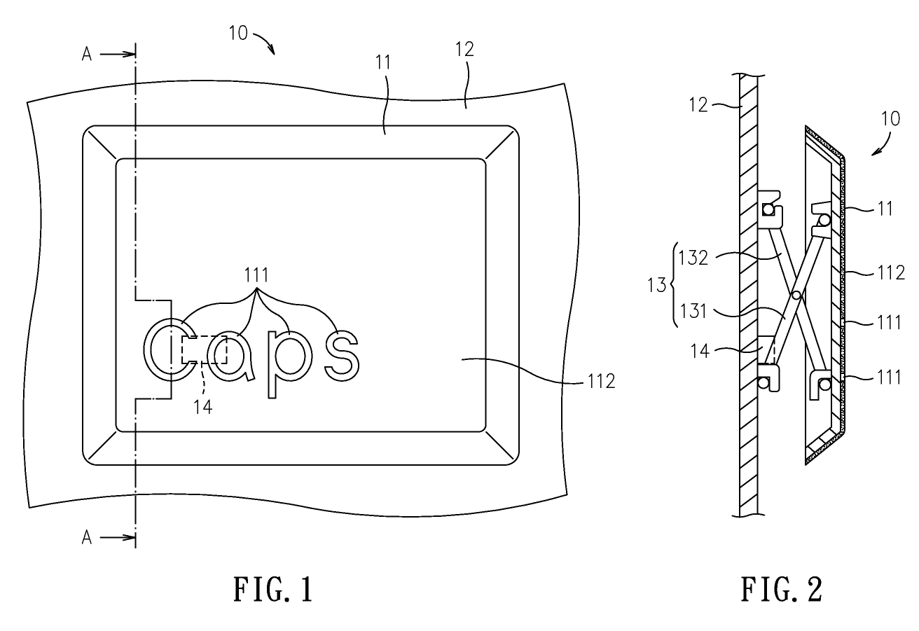

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

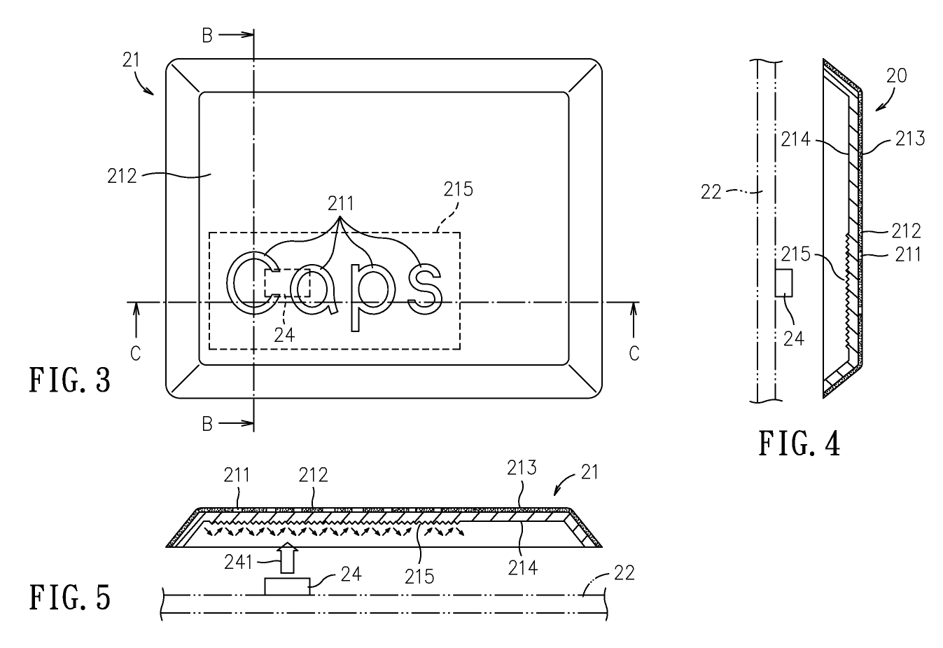

Please refer to FIG. 3 to FIG. 5, which show a keycap according to an exemplary embodiment of the invention. The keycap 21, being made of a transparent material, is comprised of a top 213 and a bottom 214 and is formed with a pattern 211 of good light transmittance on the top 213 thereof while enabling light to be blocked by the other area of the keycap 21 except the pattern 211. There can be various ways for formed such pattern 211. One of which is a process comprising the steps of: proving a keycap 21 made of a transparent material while covering a portion of the top 213 thereof for forming a specific pattern 211; coating or spraying an opaque layer 212 on the top 213 of the keycap 21; etching the covered portion of the keycap's top 213 so as to form the specific pattern 111 of good light transmittance.

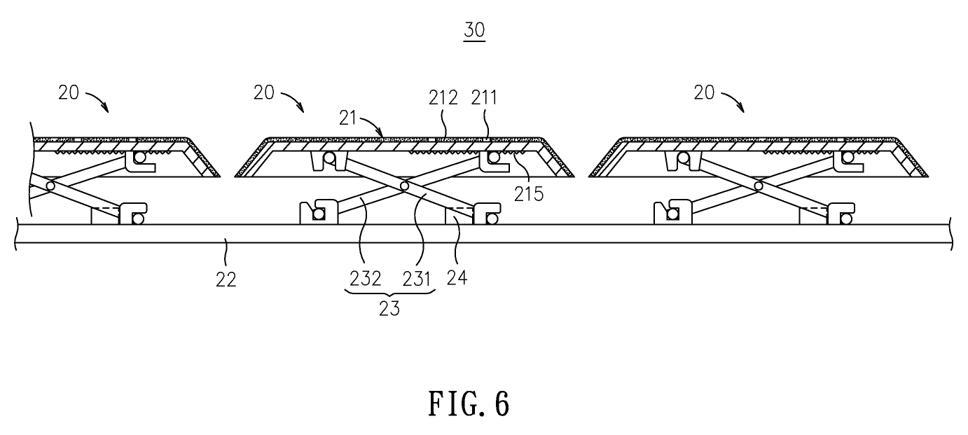

As shown in FIG. 4 and FIG. 5, there is a substrate 22 disposed under the keycap 21 for forming a space there between where there is a light source 24 disposed thereat. In addition, there is a connecting component 23 sandwiched between the keycap 21 and a substrate 23, as shown in FIG. 6. The connecting component 23, being composed of a first supporting arm 231 and a second supporting arm 232, is configured in a manner that the two supporting arms 231, 232 are pivotally coupled with each other at the middle thereof forming an X-shaped structure while pivotally connecting their top ends to the bottom 214 of the keycap 21 and connecting their bottom ends to the substrate 22, by that the keycap 21 is connected to the substrate 22 while allowing the keycap 21 to move up and down in relative to the substrate 22. Thereby, a press key 20 is constructed.

As shown in FIG. 3 to FIG. 5, the keycap of the invention is characterized in that: there is a concave-convex structure 215 formed at the bottom 214 of the keycap 21. The concave-convex structure 215 can be a light-scattering microstructure, a light-gathering microstructure, or a diffraction microstructure, formed by an embossing process using a textured mold. Moreover, it can be a regular structure or an irregular structure. As soon as the light 214 from the light source 24 is projected onto the concave-convex structure 215 on the bottom 214 of the keycap 21, the light 214 will be evenly scattered by the repeating reflections, refractions or diffractions happening as the light 214 is traveling inside the concave-convex structure 215, as shown in FIG. 5, and then being projected out of the keycap 21 through the transparent pattern 211 formed on the top 213 of the keycap 21. Thereby, the pattern 211 is lighted with uniform brightness.

Accordingly, the concave-convex structure 215 is formed on the bottom 214 of the keycap 21 according to actual requirement. For instance, it can be a light-gathering microstructure formed at the portion of the pattern that is not sufficiently illuminated, or can be a light-scattering microstructure formed at the portion of the pattern that is too bright. In this exemplary embodiment, the concave-convex structure 215 is disposed on the bottom 214 of the keycap 21 at a position corresponding to the pattern 211, but it is distributed in an area on the bottom 214 according to actual requirement and thus is not limited the present embodiment.

Please refer to FIG. 6, which is a schematic diagram showing a keyboard composing of a plurality of press key structures according to the present invention. As shown in FIG. 6, by arranging a plurality of the aforesaid press keys 20 on a same substrate 23, a keyboard 30 can be constructed

To sum up, the present invention provides a keycap capable of using a concave-convex structure formed on the bottom thereof to uniformly scatter the light projected on the bottom and then allowing the light to be projected out from the top of the keycap evenly, and thus provide a press key structure and keyboard with glittering patterns.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A keycap designed for allowing light to pass therethrough, comprising:
a top; and
a bottom, having a concave-convex structure formed thereon.

2. The keycap of claim 1, wherein the concave-convex structure is formed by an embossing process using a textured mold.

3. The keycap of claim 1, wherein the concave-convex structure is a structure selected from the group consisting of: regular structures and irregular structures.

4. The keycap of claim 1, wherein the concave-convex structure is a microstructure selected from the group consisting of: a light-scattering microstructure, a light-gathering microstructure, and a diffraction microstructure.

5. The keycap of claim 1, wherein the keycap is formed with a pattern of good light transmittance and is capable of blocking light from passing through other area of the keycap except the pattern.

6. The keycap of claim 5, wherein the concave-convex structure is disposed on the bottom of the keycap at a position corresponding to the pattern.

7. A press key structure, comprising:
a keycap, configured with a top a bottom, having a concave-convex structure formed thereon, and being formed for allowing light to pass therethrough;
a substrate;
a connecting component, sandwiched between the keycap and the substrate in a manner that it is pivotally connected to the two in respective for allowing the keycap to move up and down in relative to the substrate; and
at least a light source, each being disposed at a position between the keycap and the substrate for projecting light to the concave-convex structure on the keycap′ bottom and out of the keycap through the top thereof after being uniformly scattered by the concave-convex structure.

8. The press key structure of claim 7, wherein the concave-convex structure is formed by an embossing process using a textured mold.

9. The press key structure of claim 7, wherein the concave-convex structure is a structure selected from the group consisting of: regular structures and irregular structures.

10. The press key structure of claim 7, wherein the concave-convex structure is a microstructure selected from the group consisting of: a light-scattering microstructure, a light-gathering microstructure, and a diffraction microstructure.

11. The press key structure of claim 7, wherein the keycap is formed with a pattern of good light transmittance and is capable of blocking light from passing through other area of the keycap except the pattern.

12. The press key structure of claim 11, wherein the concave-convex structure is disposed on the bottom of the keycap at a position corresponding to the pattern.

13. The press key structure of claim 7, wherein each light source is a light emitting diode.

14. A keyboard, comprising:
a plurality of key caps, each configured with a top a bottom, having a concave-convex structure formed thereon, and being formed for allowing light to pass therethrough;
a substrate;
a plurality of connecting components, each sandwiched between its corresponding keycap and the substrate in a manner that it is pivotally connected to the two in respective for allowing its corresponding keycap to move up and down in relative to the substrate; and
at least a light source, each being disposed at a position between the plural keycaps and the substrate for projecting light to the concave-convex structures on the keycap′ bottoms and out of the keycaps through the tops thereof after being uniformly scattered by the concave-convex structures.

15. The keyboard of claim 14, wherein the concave-convex structures are formed by an embossing process using a textured mold.

16. The keyboard of claim 14, wherein the concave-convex structure is a structure selected from the group consisting of: regular structures and irregular structures.

17. The keyboard of claim 14, wherein the concave-convex structure is a microstructure selected from the group consisting of: a light-scattering microstructure, a light-gathering microstructure, and a diffraction microstructure.

18. The keyboard of claim 14, wherein the keycap is formed with a pattern of good light transmittance and is capable of blocking light from passing through other area of the keycap except the pattern.

19. The keyboard of claim 18, wherein the concave-convex structure is disposed on the bottom of the keycap at a position corresponding to the pattern.
The keyboard of claim 14, wherein each light source is a light emitting diode.
